(19) United States
(12) Patent Application Publication
(10) Pub. No.: US 2011/0042285 A1
(43) Pub. Date: Feb. 24, 2011

(54) Vehicle for Introducing Alkaline Materials Into Bodies of Water

(76) Inventors: Günter Scholz, Hoyerswerda (DE); Wolfgang Rabe, Bernsdorf (DE); Christopher Pust, Dusseldorf (DE); Heiko Saure, Gevelsberg (DE)

Correspondence Address: Jonathan P. O''Brien, Ph.D.;Honigman Miller Schwartz and Cohn LLP, 350 East Michigan Avenue, Suite 300, KALAMAZOO, MI, 49007, US

(21) Appl. No.: 12/677,424

(22) PCT Filed: Sep. 12, 2008
(86) PCT No.: PCT/EP2008/062141

§ 371 Date: Jun. 24, 2010

(30) Foreign Application Priority Data
Sep. 13, 2007 (DE) 10 2007 043 750.3
Dec. 19, 2007 (DE) 20 2007 017 852.2

(51) Int. Cl. B63B 35/00; C02F 1/66

(52) U.S. Cl. 210/170.05; 114/343

(57) ABSTRACT

The invention relates to a self-propelled water vehicle (1) for introducing alkaline materials into bodies of water. The invention is characterized in that the water vehicle (1) has at least one supply container (2) for alkaline materials, at least one intake device (3) for water from the body of water, at least one metering device (4) for producing a suspension, and at least one delivery pump (5) and at least one distributor nozzle (6a, b), connected to the least one delivery pump (5), for spraying the suspension onto the water surface, the water vehicle (1) being dimensioned with regard to dimensions and empty weight such that it can be transported overland to the respective usage location thereof using a transport vehicle (7).

The invention relates to a water vehicle for introducing alkaline materials into acidic bodies of water in order to neutralise and subsequently treat such bodies, particularly mining lakes, which are highly acidic due to the process by which they came into being, and require prolonged subsequent treatment in order to maintain the neutral conditions of the water due to the inflow of acidic groundwater streams. Furthermore the invention relates to an arrangement for introducing alkaline materials into bodies of water.

If neutral, hydrochemically acceptable conditions are not created in these bodies of water, they cannot be connected to the public network of open watercourses. Moreover, the inflow of acidifying groundwater and consequential contact with the atmosphere that occurs in mining lakes leading to oxidation processes, particularly converting bivalent and trivalent iron among other elements, causes the acidity in the water to increase further, so that the lake functions as an acid generator and the areas downstream of the lake are contaminated with acidic groundwater, and possibly surface water as well.

Therefore, in most cases it is necessary to implement a cyclically repeating programme of follow-up treatment for such bodies of water in addition to the initial neutralisation, in order to maintain neutral conditions.

It is known from the prior art that “in-lake methods” can be used to ensure both initial neutralisation and subsequent treatment of these bodies of water.

According to German Patent No. DE 19961243, it is possible to neutralise acidic mining lakes by resuspending ashes from power plants, which are a by product of burning lignite for example, with residual alkalinity. However, this method is limited to sites where such residues are available in the vicinity. It is not financially justifiable to transport such substances to the site from longer distances.

Another method, described in application no. DE 103 04 009.9, is designed to use in-lake technology to distribute alkalysing substances, such as calcium hydroxide (Ca(OH)₂), quicklime (CaO), or corresponding dolomites or caustic soda, in the water with special distribution devices, thus maximising the quantity of the substance that is converted to alkalinity in the lake, and resulting in highly effective deacidification. For this purpose, the distribution device is in the form of a distributing pipeline that is 50 m to 2000 m long and 5 cm to 40 cm wide, and is placed so that it floats in the water on buoyancy devices. However, the costs of such a method are prohibitive in most cases, and it has therefore rarely been applied.

German Patent No. DE 20 2004 002 159.5 describes an apparatus consisting of a combination of a tank/silo vehicle, an intermediate storage receptacle, and a floating, mobile feed device in the form of a tank having a plurality of discharge apertures and floating on a pontoon, which is pulled over the open water by a water vehicle (a towboat). The possible active substances are distributed via special devices on the mobile floating unit. However, in most application cases it is not possible to present any economically viable projects with a solution of this kind either.

The object of the invention to create a mobile device for discharging alkalysing materials into acidic bodies of water that is suitable both for the initial neutralisation and for follow-up treatment, and that is constructed very simply, ensures a high specific output in terms of discharging the materials, particularly in conjunction with high degrees of conversion of the alkaline agent used, and that may be deployed to neutralise bodies of water in various locations without significant effort and cost.

The object is solved according to the invention with a self-propelled water vehicle for introducing alkaline materials into bodies of water, in that the water vehicle has at least one supply container for alkaline materials, at least one intake device for water from the body of water, at least one metering device for producing a suspension, and at least one delivery pump and at least one distributor nozzle connected to the at least delivery pump for spraying the suspension onto the water surface, the water vehicle being dimensioned with regard to its dimensions and empty weight such that it can be transported over land to each deployment site where it is to be used using a transport vehicle.

The various components necessary for neutralising bodies of water, including an intake device for collecting water from the lake, a metering device for producing a suspension from the collected water and the alkaline substance or substances to be used, delivery units for the suspension and a distributor device for spraying the suspension onto the water surface, are combined in the water vehicle according to the invention to form a highly mobile, technical unit in such manner that optimum conditions are assured for the greatest cost effectiveness according to the specific conditions of the respective body of water. The water vehicle is designed such that it is deployable with road transport vehicles and with the aid of mobile auxiliary equipment at any waterside location of a mining lake. The arrangement for storing the neutralisation materials in the water vessel is designed such that either solid or liquid materials may be used. Use of a distributor nozzle for spraying the suspension over the surface of the water creates a wide radius of action, so that a large area of water may be treated with a relatively small number of discharging passes. In this way, it is possible to treat acidic waters highly effectively, quickly and at optimum cost, both as part of an initial neutralisation and a follow-up treatment programme.

Quicklime, dolomitic lime, lime and dolomitic slurry, calcium hydroxide, dolomitic calcium hydroxide, caustic soda and similar products are preferably used as alkalysing agents. These products are preferably mixed with the water stream on the intake side of the delivery unit via a metering device that precisely regulates the concentration of the alkali used in the suspension to be discharged in each case.

According to a first embodiment of the invention, it is provided that the water vehicle has a length between 5 and 15 m, preferably 5 to 12 m, a width of 2 to 4 m, preferably 3.0 to 3.5 m, and a height of 1.5 to 4 m. This ensures a sufficiently large holding capacity of the water vehicle—the supply container preferably has a capacity of ≧3 m³—for the alkaline materials. On the other hand, it also ensures that the water vehicle is able to be loaded onto an appropriate transport vehicle and immediately transported between various deployment sites on public roads. To this end, the empty weight of the water vehicle is preferably not more than 20 t, particularly not more than 12 t. The concentration of material per unit of area on the surface of the body of water that is required for economically optimal material consumption is controlled via the travelling speed of the water vehicle, which is preferably in the range from 2 to 30 km/h, and via the suspension concentration set in the metering device so as to ensure that the material is fully converted in the body of water. The individual travel cycles of the boat with regard to time and place are adapted to the morphology and weather conditions at the respective deployment site.

The concentration of material in the suspension to be discharged may be controlled using a control unit either by a flow controller provided in the metering device to control the flow of the alkaline materials to be used to the intake line of the suspension delivery pump, or by the quantity of water that is collected from the lake.

According to a further advantageous embodiment of the invention, the intake aperture of the intake device is provided on the front side of the water vehicle. This position in the direction of travel of the water vehicle ensures that the dynamic pressure created by the travel speed of the boat is used energetically to collect the water for producing the suspension.

Particularly in the early stages of neutralisation, a body of water such as a mining lake still has a very low pH value, and is therefore highly corrosive. Accordingly, at least the outer skin of the water vehicle according to the invention is made from a corrosion-resistant material, preferably a corrosion-resistant metallic material. The outer skin is preferably made primarily from aluminium.

In order to ensure that the alkaline suspension is discharged evenly and over a wide area, the design and alignment of the at least one distributor nozzle provided according to the invention on the water vehicle is critically important. According to a further advantageous embodiment of the invention, it is therefore provided that the water vehicle has two distributor nozzles, and each of the distributor nozzles discharges the suspension to one side of the water vehicle, respectively, and at an angle (α) from 30° to 110° relative to the direction of travel of the water vehicle, and also at an angle (β) from 10° to 60° relative to the surface of the water. The distributor nozzles are preferably dimensioned and cooperate with the at least one delivery pump in such manner that the suspension is discharged at an ejection speed of 5 to 50 m/s.

Besides discharging the alkaline suspension onto the surface of the body of water, it may also be useful to introduce the suspension directly into deeper water layers, particularly the hypolimnion. For this purpose, the water vehicle is preferably equipped with at least one distributor nozzle below the waterline in order to introduce the suspension to deeper layers of water.

The object described in the introduction is further solved by an arrangement for introducing alkaline materials into bodies of water, wherein the arrangement comprises a water vehicle according to any one of claims 1 to 11, and a transport vehicle for transporting the water vehicle over land, and a supply container for the alkaline material or materials, from which the water vehicle may be refilled.

A heavy goods vehicle is preferably used as the transport vehicle. The supply container for the alkaline material or materials is preferably in the form of a tanker truck, thus ensuring that the entire arrangement is fully mobile at all times.

In the following, the invention will be explained in greater detail with reference to a drawing representing an embodiment thereof. In the drawing:

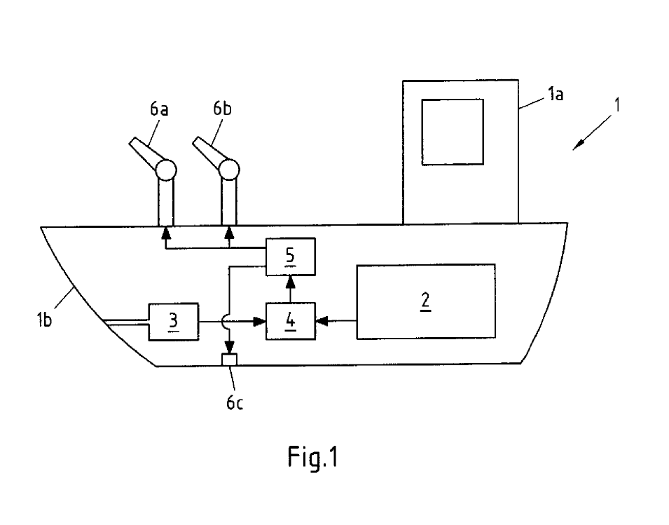

FIG. 1 is a partial cutaway side view of a self-propelled water vehicle according to the invention for introducing alkaline materials into a body of water,

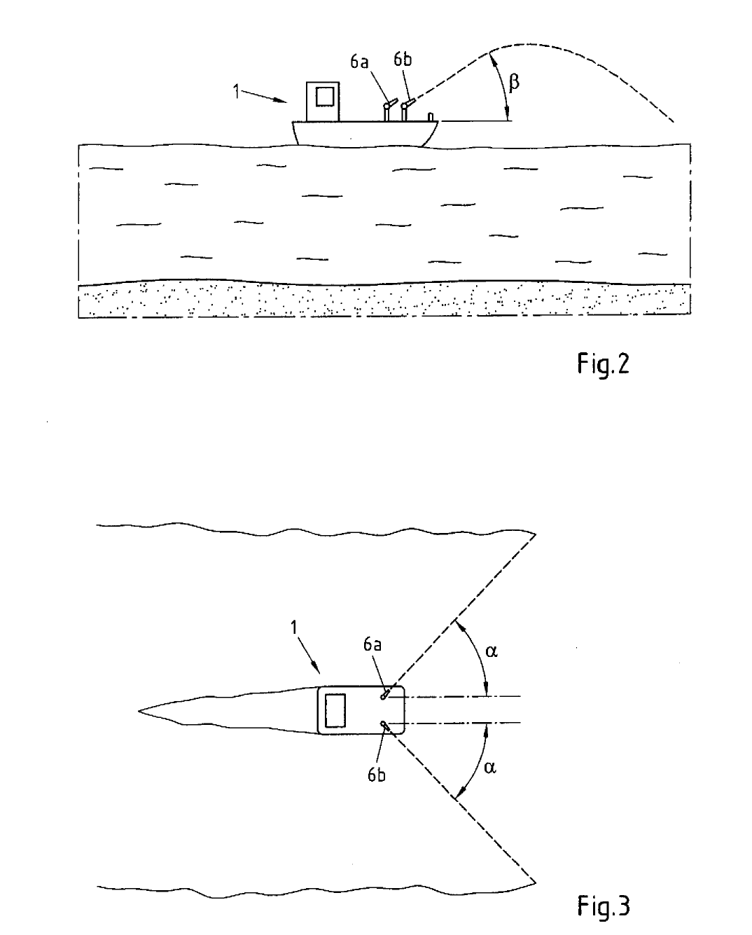

FIG. 2 is a side view of spraying of a suspension produced from the alkaline material and lake water through distributor nozzles of the water vehicle of FIG. 1,

FIG. 3 is a top view of spraying the suspension by the water vehicle of FIG. 1,

FIG. 4 shows the water vehicle of FIG. 1 loaded onto a transport vehicle,

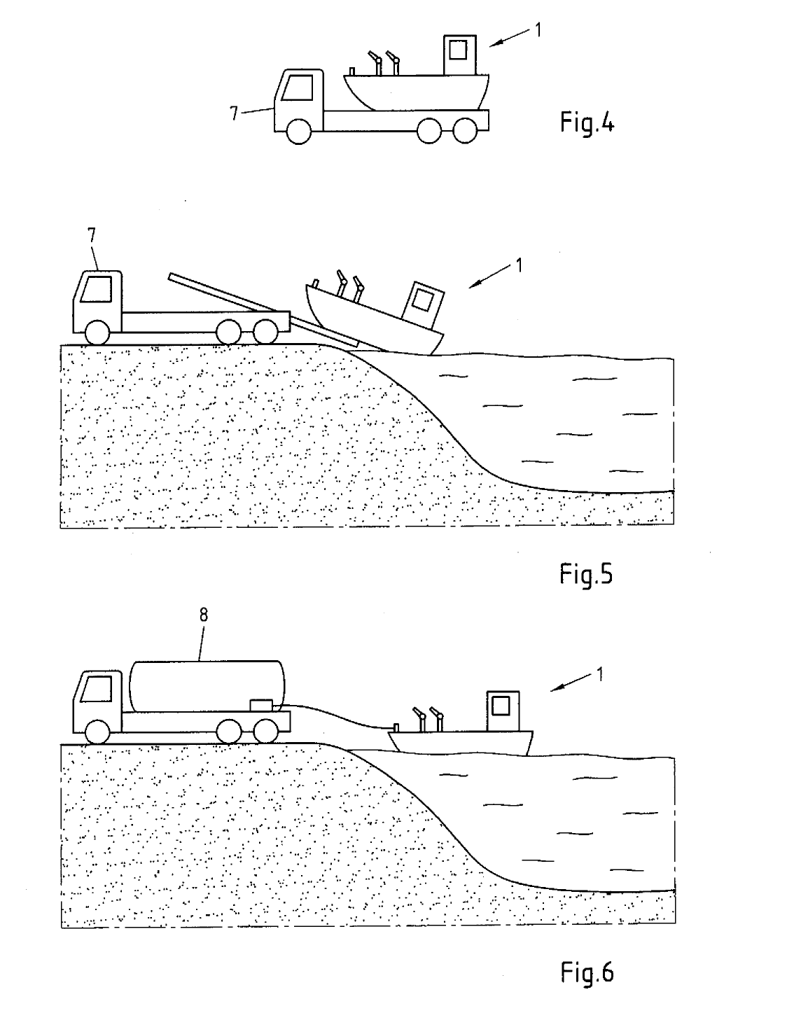

FIG. 5 shows the water vehicle of FIG. 1 being launched, and

FIG. 6 shows the water vehicle of FIG. 1 being filled with an alkaline material for spraying onto the water surface.

FIG. 1 shows a self-propelled water vehicle for introducing alkaline materials into bodies of water according to the invention. In the present case, the water vehicle has the form of a boat 1 and includes an operator's cabin 1a, also drive and steering means (both not shown) aft. According to the invention, a supply container 2 for alkaline materials, an intake device 3 for water from the body of water that is to be neutralised, a metering device 4 for producing a suspension from the water collected and the alkaline material stored in supply container 2, and a delivery pump 5 are located in the hull of boat 1. Delivery pump 5 is connected to two distributor nozzles 6a, 6b located on the foredeck for spraying the suspension produced in metering device 4 onto the surface of the body of water that is to be neutralised.

In the present case, boat 1 also includes an additional nozzle 6c, which is located in the keel area of boat 1 and is directed downwards, so that the suspension produced in metering device 4 may also be introduced into deeper layers of water via delivery pump 5. A control device, which is also provided in hull 1b of the boat, and with which the suspension concentration in metering device 4 may be adjusted precisely, is not shown.

According to the invention, boat 1 is dimensioned with regard to its dimensions and empty weight such that it is able to be transported over land to each deployment site using a transport vehicle 7 (see FIGS. 4 and 5). To this end, boat 1 has a length of 5-15 m, preferably 8-12 metres, a width of 2-4 m, preferably 3-3.5 m, and a height of 1.5-4 m. The empty weight of boat 1 is no more than 20 tons, in the present case 10 tons, so that it may easily be transported on public roads between the various deployment sites when loaded on transport vehicle 7. The loading capacity of boat 1 is also approximately 10 tons for a fully loaded total weight of 20 tons at the start of a travel cycle. Since acidic bodies of water readily attack corrodible materials, particularly in the early stages of neutralisation, in this case at least the outer skin of boat 1 is made from a corrosion-resistant material, particularly aluminium.

According to the invention, the suspension produced in metering device 4 is discharged onto the surface of the body of water via a distributor nozzle system. This system comprises one or more individual nozzles located in fixed or movable manner in the forward area of boat 1. As was indicated previously, the distributor nozzle system in the present case consists of two swiveling distributor nozzles 6a, 6b located on the foredeck. As shown in FIG. 3, these nozzles are arranged side by side, thus covering the port side (nozzle 6a) and the starboard side (nozzle 6b) of boat 1. However, nozzles 6a, 6b are shown one behind the other in the side views of FIGS. 1, 2 and 4-6, for the sake of clarity. In the present case, distributor nozzles 6a, 6b may be swiveled both horizontally (angle range α, see FIG. 3) in vertically (angle range β, see FIG. 2). Thus for example, distributor nozzles 6a, 6b may each be swiveled through an angle α of 30°-110° relative to the direction of travel of boat 1, and at the same time through an angle β of 10°-60° relative to the surface of the water. Distributor nozzles 6a, 6b are also dimensioned and cooperate with delivery pump 5 in such manner that the suspension produced in metering device 4 is sprayed onto the water surface at a discharge speed of 5-50 m/s. In this way, it is possible to establish a precise droplet spectrum and carpet the water surface evenly with the alkaline suspension on both sides of boat 1, as shown in FIG. 3, the width of the treatment carpet formed thereby being preferably between 10 and 80 m on either side of boat 1.

The concentration of material per unit of area on the surface of the body of water that is required for economically optimal material consumption is controlled via the travelling speed of the water vehicle in the range from 2 to 30 km/h, and via the suspension concentration produced in metering device 4 in such a way that the material is completely converted in the body of water. In this context, the individual travel cycles of the boat with regard to time and place are adapted to the morphology and weather conditions at the respective deployment site.

The concentration of material in the suspension to be discharged may be controlled in metering device 4 using a control unit either by controlling the flow of the alkaline materials used to the intake line of suspension delivery pump 5, or by controlling the quantity of water that is collected from the lake.

In the following, the principle of the invention will be explained again with reference to a specific example.

Transportable water vehicle (boat) 1 according to the invention, having a total weight of 20 t and a loading capacity of 10 t alkaline materials travels over the body of water to be treated at a speed of 25 km/h. The lake water required for producing the suspension is fed into the intake line of suspension delivery pump 5 through a submerged opening in the forepart of boat 1 at a rate of 500 m³/h. The alkaline material is fed from supply container 2 of boat 1 into the intake line of pump 5 in a metered quantity of 100 m³/h via a metering device 4, thus producing a 20% suspension. This suspension is fed to delivery pump 5, by which it is pressurised to 4 bar, which is necessary for discharging the suspension over a wide area, and is forwarded to distributor nozzles 6a, 6b via a pipe system. Distributor nozzles 6a, b eject the suspension at a nozzle discharge speed of 25 m/s to the right and left of the travel direction of boat 1 and at an angle α relative to the direction of travel of 80 degrees onto to the water surface, thereby creating a 30 m wide carpet-liked swath in which the water surface is treated on both the left and right sides of boat 1, and in which the alkaline material immediately reacts with the lake water and is completely converted. The material concentration that may be produced on the lake surface within 10 minutes with the treatment area of 125,000 m² that is reached in this way creates highly favourable reaction conditions for 100% conversion of the material in the body of water that is to be treated. The concentration of the alkaline material being used is adapted respectively to the lake water conditions via metering device 4 and a regulating system. The individual travel patterns of boat 1 are arranged so that the entire water volume in the hypolimnion of the body of water is evenly charged with alkaline material by taking into account the morphology of the respective body of water and the wind-induced currents prevailing on the water surface.

Whereas in the present case boat 1 is equipped with operator's cabin 1a so that a pilot is able to control and monitor the travel cycle directly, of course such travel cycles may also be controlled remotely from the waterside, for example with the aid of GPS technology.

FIGS. 4 to 6 illustrate an arrangement according to the invention for introducing alkaline materials into bodies of water. This arrangement includes a boat 1, as described previously, and a transport vehicle 7 for transporting boat 1 over land, and a unit 8 for storing the alkaline material or materials, from which boat 1 may be replenished. In the present case, storage unit 8 is in the form of a tanker truck 8, and thus is also mobile. In FIG. 4, boat 1 is shown in the condition of having been loaded onto transport vehicle 7. FIG. 5 shows how boat 1 is launched into the water on the shore of a body of water to be neutralised, for example a mining lake, via a suitable ramp unit 7a, which is part of the equipment of transport vehicle 7. Boat 1 is loaded onto the vehicle correspondingly, for example using a winch. FIG. 6 shows how the boat 1, now floating on the water, is loaded with the alkaline material, for example calcium hydroxide, via a suitable line immediately before starting its travel cycle. Other methods of loading in the case of solid alkaline materials, for example via a dump truck, are also possible.

1.-13. (canceled)

14. A self-propelled water vehicle for introducing alkaline materials into bodies of water, wherein said water vehicle has;
at least one supply container for alkaline materials,
at least one intake device for taking in water from the body of water,
at least one metering device for producing a suspension,
at least one delivery pump and
at least one distributor nozzle
connected to said delivery pump for spraying the suspension onto the water surface, wherein said water vehicle is of a size and empty weight such that it can be transported over land using a transport vehicle.

15. The water vehicle according to claim 14, wherein said water vehicle has a length between 5 and 15 m, a width of 2 to 4 m, and a height of 1.5 to 4 m.

16. The water vehicle according to claim 15, wherein said empty weight of the water vehicle is not more than 20 t.

17. The water vehicle according to claim 15, wherein said empty weight of the water vehicle is not more than 12 t.

18. The water vehicle according to claim 16 wherein at least one supply container (2) has a capacity greater than or equal to 3 m³.

19. The water vehicle according to claim 18, wherein said intake aperture of the intake device is provided on the front side of the water vehicle.

20. The water vehicle according to claim 19, wherein the outer skin of the water vehicle is made from a corrosion-resistant material.

21. The water vehicle according to claim 20, wherein said outer skin is made primarily from aluminium.

22. The water vehicle according to claim 14, wherein said water vehicle has two distributor nozzles, and each of said distributor nozzles discharges said suspension to one side of said water vehicle, respectively, at an angle (α) from 30° to 110° relative to the direction of travel of the water vehicle, and simultaneously at an angle (β) from 10° to 60° relative to the surface of the water.

23. The water vehicle according to claim 22, wherein at least one distributor nozzle is connected to and cooperates with at least one delivery pump in such manner that the suspension is discharged at an ejection speed of 5 to 50 m/s.

24. The water vehicle according to claim 23 wherein said water vehicle includes a drive device that enables the boat to travel at a speed between 2 and 30 km/h.

25. The water vehicle according claim 24 wherein said water vehicle has at least one distributor nozzle placed below the waterline of said water vehicle for introducing said suspension into deeper layers of water.

26. An arrangement for introducing alkaline materials into bodies of water, wherein the arrangement includes a water vehicle according to claim 14, and a transport vehicle for transporting said water vehicle over land, and a storage unit to contain the alkaline material or materials which can be used to replenish said water vehicle.

27. The arrangement according to claim 26 wherein said storage unit is in the form of a tanker truck.
